(19) United States
(12) Patent Application Publication
(10) Pub. No.: US 2025/0135398 A1
(43) Pub. Date: May 1, 2025

(54) PROCESS FOR TREATING A NOX CONTAINING GAS

(71) Applicant: CASALE SA, Lugano (CH)

(72) Inventors: Pasquale TALARICO, Viganello (CH); Iacopo CEREA, Lugano (CH)

(21) Appl. No.: 18/834,029

(22) PCT Filed: Feb. 20, 2023
(86) PCT No.: PCT/EP2023/054231

§ 371 Date: Jul. 29, 2024

(30) Foreign Application Priority Data
Feb. 25, 2022 (EP) 22158793.4

(51) Int. Cl. B01D 53/56; B01D 53/00; B01D 53/34; B01D 53/78

(52) U.S. Cl. CPC B01D 53/56; B01D 53/002; B01D 53/343; B01D 53/78; B01D 2251/504; B01D 2252/103; B01D 2257/404

(57) ABSTRACT

A process for treating a NOx-containing gas resulting from a leaching process wherein said leaching process includes the treatment of ores with nitric acid to separate materials contained in the ores, and said leaching process releases a diluted nitric acid solution and said NOx-containing gas and wherein the treatment of said NOx containing gas includes an absorption step in presence of make-up water and/or in presence of diluted nitric acid, obtaining a concentrated nitric acid and a tail gas containing residual NOx.

### FIELD OF APPLICATION

The invention is in the field of treating a NOx-containing gases from leaching processes.

### PRIOR ART

Ores are natural rocks or sediments that contain one or more valuable metals or minerals, including for example oxides, sulfides, silicates, or native metals such as copper or gold, that can be mined, treated and sold at a profit.

Typically, ores are first extracted through mining and subsequentially treated to recover the valuable metals or minerals contained therein. Several treating stages are required to extract metals and rare elements from ores including leaching, separation and neutralization.

For instance, precious elements can be recovered by treating ores with a leaching medium such as diluted nitric acid to dissolve said precious metals in said acid. Once obtained, the diluted nitric acid solution containing the precious metals is subjected to a specific separation and neutralization process to isolate the precious elements from inerts and from the acid solution.

Being a strong oxidizer, nitric acid is very effective as a leaching medium; however, the use of nitric acid involves the generation of NOx containing gases, as byproducts, during the extraction process or further purification steps.

The amount of NOx generated during the extraction process depends on the size of the mines and on the extension of the purification process, however the quantity of NOx produced is, in most cases, considerable and the gas needs be treated before discharge into atmosphere. Specific treatments designed to treat such NOx streams operate at atmospheric or nearly atmospheric pressure and use chemical reactants including MgO, CaO and alkali that need further post-treatments. Accordingly, these treatments have the drawbacks that they depend on chemicals, and both the supply of chemicals and their post-treatments represent a significant cost.

In recent years, the applicable legislation has evolved to impose very stringent limits on the NOx emission into the atmosphere. The above-described treatments adopted in the prior art are not able to meet such requirements at an acceptable cost. Therefore, it is highly desirable to find an improved process for treating the NOx-containing gas generated in the leaching process as described above.

An overview of prior art can be found in the following documents: US 2017/0356067 describes an acid digestion process for recovery of rare earth elements from coal and coal byproducts. U.S. Pat. No. 4,670,051 describes an oxidation process for releasing metal values in which nitric acid is regenerated in situ. U.S. Pat. No. 3,965,239 discloses recovery of nitric acid soluble transition metals from sulfur and iron containing ores of the same. GB 2 370 567 discloses a process for extracting precious metal from waste material. US 2019/0218097 discloses a process for producing nitric acid. EP 3 372 556 discloses a plant for production of nitric acid. U.S. Pat. No. 4,138,470 discloses a method of preventing escape of nitrogen oxides from aqueous nitrate solution. US 2010/0024476 discloses recovery of carbon dioxide from flue gas.

### SUMMARY OF THE INVENTION

The invention aims to overcome the above drawbacks of the prior art. In particular, the present invention seeks to improve the economic and environmental sustainability of conventional processes.

Accordingly, one aspect of the present invention is a process for treating a NOx-containing gas resulting from a leaching process wherein: said leaching process includes the treatment of ores with nitric acid to separate materials contained in the ores, and said leaching process releases a diluted nitric acid solution and said NOx-containing gas.

The treatment of said NOx containing gas includes an absorption step in presence of make-up water and/or in presence of diluted nitric acid, obtaining a concentrated nitric acid and a tail gas containing residual NOx.

A further aspect of the present invention is a process for treating a NOx containing gas according to claim 14, wherein the NOx containing gas includes NO, NO₂ and N₂O₄ and the sum of NO, NO₂ and N₂O₄ in said NOx containing gas is comprised between 3 to 60% mol or preferably between 5 and 20% mol.

The process comprises the steps of subjecting said NOx containing gas to compression and to a temperature adjusted step before absorbing NOx in water and/or in diluted nitric acid solution to generate a concentrate nitric acid and a tail gas.

The process further includes the step of subjecting said tail gas produced during absorption to a suitable heat recovery step and to an expansion step to generate power that is exploited in the compression step.

A further aspect of the present invention is a gas treatment section adapted to treat a NOx-containing gas from a leaching section according to the claims.

In the leaching section ores are contacted with a nitric acid to generate a diluted nitric acid solution containing target elements separated from said ores, and a NOx containing gas is produced.

The gas treatment section comprises an absorption unit in fluid communication with said leaching section and configured to contact a NOx containing gas with a make-up water and/or diluted nitric acid to generate a concentrate nitric acid.

The above-described process is particularly advantageous because it valorizes said NOx containing gas by contacting said gas with water to generate concentrated nitric acid in the absorption step. Said concentrated nitric acid can be advantageously recycled back into the process so that the fresh import of nitric acid in the leaching process is reduced and the economic viability of the process is increased.

Even more advantageously, the energy efficiency of the plant is optimized because the power generated during expansion can be exploited, at least in part, to fulfil the energy demand of the compressor.

In addition, the process of the present invention allows to control and to adjust the amount of NOx emitted into the atmosphere with a suitable DeNOx stage arranged prior to the expansion step or, in alternative, the absorption step can be configured to absorb the NOx gas so to ensure that the tail gas leaving the absorption step has a NOx content already in compliance with the environmental regulation. The term DeNOx stage denotes a stage adapted to remove NOx from the gas.

In all the two above mentioned options no costly chemicals are required to remove the NOx and no additional post treatments are required to recover said chemicals. An interesting advantage of the invention is a reduced operational expenditure (OPEX) in the treatment of large flow rates of nitrous gas.

### DETAILED DESCRIPTION OF THE INVENTION

According to the invention, concentrated nitric acid is recovered in the absorption step and separated from a tail gas containing residual NOx. Preferably, at least a portion of said concentrated nitric acid is recycled as a leaching agent to the leaching process to reduce the fresh import of nitric acid in the process.

According to a particular preferred embodiment, the process further includes a compression step wherein said NOx-containing gas is subjected to compression to yield a pressure-adjusted gas and a first heat recovery step wherein said pressure adjusted gas is cooled in a heat exchanger to yield a temperature adjusted gas.

Preferably, the process includes a condensation step wherein said temperature adjusted gas is subject to condensation to yield a condensate stream and a nitrous gas and an absorption step wherein said condensate stream and said nitrous gas are subjected to an absorption step in presence of make-up water and/or diluted nitric acid to yield a concentrated nitric acid and a tail gas containing residual NOx.

Preferably, the process includes to subject said tail gas containing residual NOx to a second heat transfer step wherein said tail gas containing residual NOx is heated to yield a heated tail gas and in addition said heated gas is expanded in an expansion step to generate power.

According to an interesting application of the invention, at least part of the power recovered from the expansion of said tail gas is used for said compression step.

According to another interesting application of the invention, the first heat transfer and the second heat transfer step are performed in a single heat exchanger, wherein heat removed from the pressure adjusted gas is transferred to the tail gas. Preferably, the heat exchanger is a shell and tube heat exchanger wherein the pressure adjusted gas flow in the shell side of the heat exchanger whilst the tail gas flows in the tube side of the heat exchanger.

According to a preferred embodiment, the process further includes a heating step wherein the heated tail gas is further heated before being fed to said expansion step. This embodiment is particularly preferred during start-up operation when the plant is substantially in a “cold state” and a certain amount of time is required to reach a steady state condition.

According to an interesting embodiment of the invention, the heated gas eventually after additional heating is subjected to a NOx removal step prior to be supplied to said expansion step. The NOx removal step is particularly advantageous because, if necessary, the content of NOx present in the heated tail gas can be reduced to target value dictated by the environmental regulation in force.

According to another embodiment of the invention, the absorption step is configured to treat the NOx containing gas and to ensure that the NOx content into the tail gas separated from the concentrated nitric acid in said absorption step is already in compliance with the environmental regulation. According to an embodiment of the invention, the concentrated nitric acid recovered in the absorption step can be subjected to a bleaching step in presence of air and subsequentially recycled back to the leaching step. Product of the bleaching step is also an airstream enriched in NOx that is preferably recycled to the compression step.

According to an interesting application of the invention, the concentrated nitric acid can be recovered in an absorption tower that operates at low pressure or at medium to high pressure. In the first embodiment, the NOx containing gas is subjected to a low-pressure compression step whilst in the second embodiment, the NOx containing gas is subjected to multiple compression steps including a low-pressure compression step and a high-pressure compression step.

According to an embodiment, said nitrous gas before being supplied to said absorption step is subjected in sequence to a high-pressure compression step, a heat recovery step and to a condensation step.

In embodiments when the NOx containing gas is subjected to a single compression step, said absorption step is carried out preferably in a pressure range comprised between 1.5 and 6 bara and more preferably comprised between 2 and 5 bara. The unit “bara” denotes bar absolute.

Alternatively, when said NOx containing gas is subjected to multiple compression steps, said absorption step is preferably carried out in a pressure range comprised between 4 and 15 bara and more preferably in a pressure range comprised between 5 and 11 bara.

Preferably the NOx containing gas emerging from the leaching process has a pressure comprised between 0.5 and 5 bara and more preferably between 0.8 and 2 bara.

Preferably, the pressure-adjusted gas emerging from the compression step has a temperature comprised between 150 and 250° C.

According to a particularly preferred application, the materials contained in the ores include one or more metal(s) and/or rare element(s) selected from Au, Pt, Rh, Pd Ni, Co, Fe, U and Cu.

The applicant has also found that the process of the invention can also be applied to treat NOx containing gas originated from processes other than leaching.

Preferably, the process of the invention can be used for treating a NOx containing gas, wherein said NOx containing gas includes NO, NO₂ and N₂O₄ and wherein the sum of NO, NO₂ and N₂O₄ in said NOx containing gas is comprised between 3 to 60% mol and more preferably between 5 and 20% mol.

Accordingly, the process comprises the steps of: subjecting said NOx containing gas to a compression step to yield a pressure-adjusted gas, subjecting said pressure-adjusted gas to a heat recovery step to yield a temperature adjusted gas, subjecting said temperature adjusted gas to a condensation step to yield a condensate stream and a nitrous gas and subjecting said condensate stream and said nitrous gas to an absorption step in presence of make-up water and/or diluted nitric acid to yield a concentrated nitric acid and a tail gas containing residual NOx.

The process further comprises the steps of adjusting the temperature of said tail gas containing residual NOx by transferring heat from said pressure adjusted gas to said tail gas containing residual NOx to yield a heated tail gas and subjecting said heated gas to an expansion step to recover power to be used in said compression step.

According to an interesting application, the heated tail gas, optionally after a further heating step, is subjecting to a NOx removal step before being conveyed to said expansion step.

According to an interesting embodiment of the present invention, the gas treatment section further includes a low-pressure nitric acid recovery section comprising a low-pressure compressor and a low-pressure expander connected in series wherein said low-pressure compressor has an input that is in fluid communication with said extraction section.

Said section may further include a low-pressure heat recovery section including a heat exchanger and a low-pressure condenser, said low-pressure heat recovery section is in fluid communication with an outlet of said low-pressure compressor and with an inlet of said absorption unit.

Said section may further include a line connecting said absorption unit with said low-pressure expander and a driver connected with said low-pressure compressor and with said low-pressure expander and arranged to transmit power to said low-pressure compressor.

According to an embodiment, the expander, the compressor and the driver can be part of a single unit provided with a single shaft or, in alternative, they can be part of multiple geared machines integrally connected.

According to an embodiment of the invention, the section further includes a high-pressure nitric acid recovery section in communication with said low-pressure heat recovery section and with said absorption unit. Preferably, said absorption unit is a high-pressure absorption unit.

The high-pressure nitric acid recovery section may include a high-pressure compressor and a high-pressure expander connected in series wherein said high-pressure compressor has an input that is in fluid communication with said low-pressure heat recovery section.

The section may further include a high-pressure heat recovery section including a heat exchanger and a high-pressure condenser wherein said heat exchanger is in fluid communication with an outlet of said high-pressure compressor. Preferably the plant comprises a line connecting said high-pressure heat recovery section with said absorption section.

According to an embodiment, said low-pressure compressor and said high-pressure compressor and said low-pressure expander and said high-pressure expander can be arranged in a series or in parallel of multiple machine sections.

Some preferred operating conditions of the gas treatment section and of the process are discussed hereinbelow.

The temperature of the NOx-containing gas is preferably comprised between 20° C. and 190° C. and more preferably is comprised between 40° C. to 120° C.

The NOx-containing gas may include NO, NO₂, N₂O₄, H₂O, O₂, N₂ and CO₂.

Preferably the oxidation ratio of NOx species defined as the molar ratio between NO₂ and the total amount of NOx is comprised between 10% and 100% and more preferably between 20% and 60%.

Preferably, the water H₂O content in the NOx-containing gas is comprised between 5% and 20% mol however, in some less preferred embodiments the NOx-containing gas can be saturated with water.

Preferably, the oxygen O₂ content in the NOx-containing gas is comprised between 0.5% and 20% mol and more preferably is comprised between 3% and 10% mol.

According to an embodiment, the NOx-containing gas can be added with air to increase the O₂ content in said gas to ensure that enough oxidant is available to promote the oxidation of NO to NO₂ during the subsequent cooling.

The nitrogen N₂ content in the NOx-containing gas is typically in the order of 0.5% when air is not added to the NOx-containing gas. Alternatively, when air is added to NOx-containing gas the nitrogen N₂ content can be higher than 50% mol.

The carbon dioxide content in the NOx-containing gas depends on the ores composition but preferably the carbon dioxide CO₂ content in the NOx-containing gas is comprised between 0 and 20% vol.

The NOx-containing gas can also contain in limited amounts some acids e.g. chloride acid and fluoride acid.

Preferably, the flow rate of NOx-containing gas is comprised between 1′500 Nm³/h and 120′000 Nm³/h and more preferably between 3′000 and 90′000 Nm³/h.

Preferably, the NOx recovery efficiency in the concentrated nitric acid is comprised between 80 and 99.9% and more preferably comprised between 85% and 99.9%.

Preferably, the concentrated nitric acid obtained in the absorption step is comprised between 30% and 68% and more preferably comprised between 40 and 60% wt.

### DESCRIPTION OF THE FIGURES

FIG. 1 is a schematic representation of a process for treating a NOx containing gas resulting from a leaching process according to a preferred embodiment of the invention.

FIG. 2 is a schematic representation of a process for treating a NOx containing gas resulting from a leaching process according to another embodiment of the invention.

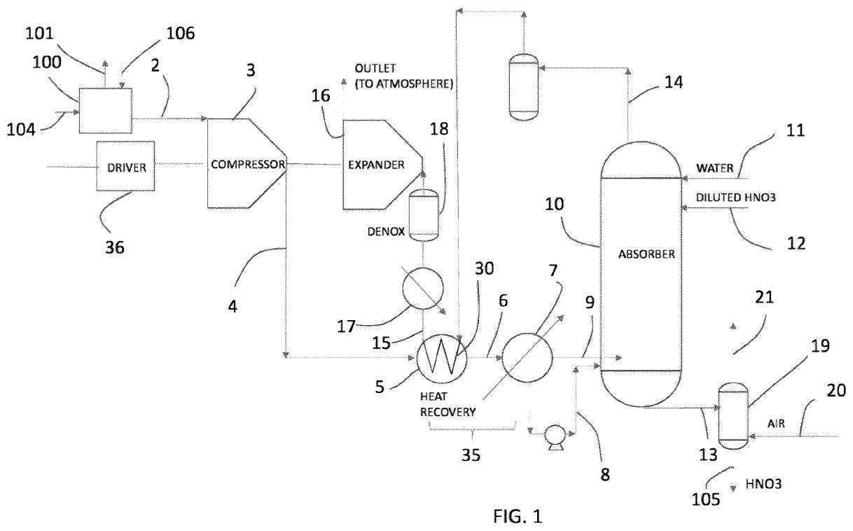

FIG. 1 discloses an embodiment wherein ores 104 are treated in a leaching section 100 in presence of nitric acid 106 to generate a NOx containing gas 2.

Said NOx containing gas 2 is subjected to a low-pressure compression step in a compressor 3 to yield a pressure-adjusted gas 4 that is subject to cooling step 5 in a heat exchanger 30 to yield a temperature adjusted gas 6. In the heat exchanger 30, the compressed gas transfers heat to the tail gas withdrawn from the absorber 10, as explained below.

The temperature adjusted gas 6 is then subjected to a condensation step in a condenser 7 to yield a condensate stream 8 and a nitrous gas 9. The condensate stream 8 and the nitrous gas 9 are sent to the absorber 10 for absorption in water 11 and in diluted nitric acid 12. The absorption step in the absorber 10 yields a concentrated nitric acid 13 and a tail gas 14 containing residual NOx.

The concentrated nitric acid 13 is subjected to a bleaching step in a bleacher 19 in presence of air 20 to yield a nitric acid 105 free from dissolved gas and a NOx-containing airstream 21. Said NOx-containing air stream 21 is then recycled to the compressor 3 (not shown).

The tail gas 14 is heated with the pressure adjusted gas 4 in the heat exchanger 30 to yield a heated tail gas 15. The heat exchanger 30 performs an indirect heat exchange so that the tail gas does not mix with the gas 4. The heated tail gas 15 can be further heated in the heat exchanger 17, if necessary, to further increase its temperature prior to be fed to a NOx removal reactor 18. Heating in the exchanger 17 may be performed to reach appropriate temperature for catalytic removal of NOx in the reactor 18.

In the NOx removal reactor 18 the tail gas 15 is purified from NOx to yield a purified gas 107. The purified gas 107 is then subjected to an expansion step in an expander 16 and then discharged into the atmosphere.

The power recovered from the expander 16 is at least in part exploited to drive the compressor 3 of the NOx containing gas. The balance of power required to drive the compressor 3 is supplied by a driver 36. Preferably said driver 36 is an electric motor. In some embodiments the compressor 3 and expander 16 may have a common shaft so that power is transferred mechanically from the expander to the compressor.

In an embodiment, at least a portion of said concentrated nitric acid 13 is recycled as a leaching agent to the leaching step 100.

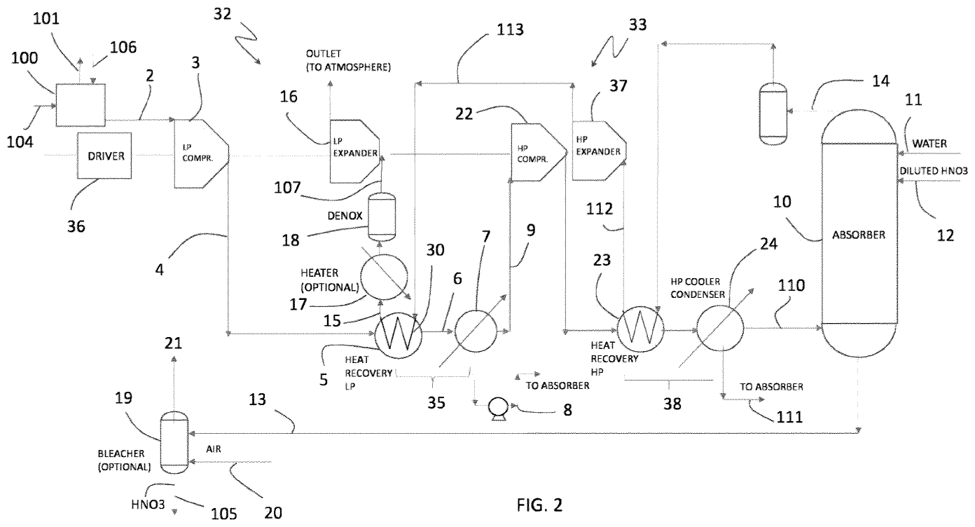

FIG. 2 illustrates an embodiment of the invention that is particularly interesting when the amount of NOx containing gas extracted from the leaching process is large. The embodiment of FIG. 2 includes a low-pressure nitric acid recovery section 32 and a high-pressure nitric acid recovery section 33.

Similar to FIG. 1, ores 104 are treated in a leaching section 100 in presence of nitric acid 106 to generate a NOx containing gas 2. The NOx containing gas 2 is subjected to a low-pressure compression in a first compressor 3 to yield a pressure-adjusted gas 4 that is subject to a cooling step 5 in a heat exchanger 30 to yield a temperature adjusted gas 6. In the exchanger 30, heat is transferred to the tail gas withdrawn from the absorber 10.

As in the previous embodiment, the temperature adjusted gas 6 is then subjected to a condensation step in a condenser 7 to yield a condensate stream 8 and a nitrous gas 9.

The condensate stream 8 is fed to the absorber 10 whilst the nitrous gas 9 is subjected in sequence to a high-pressure compression in a second compressor 22, to a cooling step in a heat exchanger 23 and to condensation in a high-pressure condenser 24. Products of the condensation are a gaseous stream 110 and a condensate 111 that are both fed to the absorber 10 together with the condensate 8.

The absorption step in the absorber 10 produces a concentrated nitric acid 13 and a tail gas 14 containing residual NOx. The concentrated nitric acid 13 is optionally subjected to a bleaching step in a bleacher 19 in presence of air 20 to yield a nitric acid 105 free from dissolved gas and a NOx-containing airstream 21. Said NOx-containing stream 21 is preferably recycled to the low-pressure compressor 3 or to the high-pressure compressor 22 (not shown). A portion of the nitric acid 13 may be used in the leaching step 100.

The tail gas 14 is sent to a heat exchanger 23 where the tail gas is heated by the nitrous gas 9 exiting the high-pressure compressor 22. The heated tail gas stream 112 is then subjected to expansion in a high-pressure expander 37 to recover power which is at least in part transferred to the high-pressure compressor 22.

Effluent of the expansion step 37 is an expanded gas 113 that is heated with the pressure adjusted gas 4 in the heat exchanger 30 to yield a heated tail gas 15. Said heated tail gas 15 can then be treated, preferably during start-up operation, in the heat exchanger 17 to further increase its temperature prior to be fed to a NOx removal reactor 18. In the NOx removal reactor 18, the tail gas is purified from NOx to yield a purified gas 107. Said purified gas 107 is subjected to expansion in the low-pressure expander 16 and then discharged into the atmosphere.

Power produced in the low-pressure expander 16 is at least in part used to drive the compressor 3 of the NOx containing gas 2. The balance of power required to drive the compressor 3 is supplied by a driver 36, preferably an electric motor.

1-21. (canceled)

22. A process for treating a NOx-containing gas resulting from a leaching process wherein said leaching process includes the treatment of ores with nitric acid to separate materials contained in the ores, and said leaching process releases a diluted nitric acid solution and said NOx-containing gas, the process comprising:
aᵢ) an absorption step in presence of make-up water and/or in presence of diluted nitric acid, obtaining a concentrated nitric acid and a tail gas containing residual NOx;
a) a compression step wherein said NOx-containing gas is subjected to compression to yield a pressure-adjusted gas;
b) a first heat transfer step wherein heat is removed from said pressure adjusted gas to yield a temperature adjusted gas;
c) a condensation step wherein said temperature adjusted gas is subject to condensation to yield a condensate stream and a nitrous gas;
d) an absorption step wherein said condensate stream and said nitrous gas is subjected to an absorption step in presence of make-up water and/or diluted nitric acid to yield said concentrated nitric acid and said tail gas containing residual NOx;
e) a second heat transfer step wherein said tail gas is heated to yield a heated tail gas;
f) an expansion step wherein said heated tail gas is expanded to recover power;
wherein said nitrous gas of step c), before being supplied to said absorption step, is further subjected in sequence to a high-pressure compression, a heat recovery, a condensation step, wherein said high-pressure compression is carried out at a pressure higher than said compression of step a).

23. The process according to claim 22, further comprising recycling at least a portion of said concentrated nitric acid as a leaching agent to said leaching step.

24. The process according to claim 22, wherein at least part of power recovered from the tail gas at step f) is used for said compression of step a).

25. The process according to claim 22, wherein the first heat transfer step and the second heat transfer step are performed in a single heat exchanger, wherein heat removed from the pressure adjusted gas is transferred to the tail gas.

26. The process according to claim 22, further comprising:
a heating step, wherein said heated tail gas of step e) is further heated before being fed to said expansion step.

27. The process according to claim 22, wherein said heated tail gas (of step e), optionally after heating, is subjected to a NOx removal step before being conveyed to said expansion step.

28. The process according to claim 22, wherein said concentrated nitric acid of step e) is subjected to a bleaching step in presence of air.

29. The process according to claim 28, wherein a product of said bleaching step is an air stream enriched in NOx, said air stream being recycled to said compression step.

30. The process according to claim 22, wherein said absorption step is carried out in a pressure range comprised between 1.5 and 6.0 bar abs.

31. The process according to claim 30, wherein said absorption step is carried out in a pressure range comprised between 4 and 15 bar abs.

32. The process according to claim 22, wherein said NOx-containing gas, emerging from the leaching process, has a pressure comprised between 0.5 and 5.0 bar abs.

33. A process for treating a NOx containing gas, wherein said NOx containing gas includes NO, NO₂ and N₂O₄ and wherein the sum of NO, NO₂ and N₂O₄ in said NOx containing gas is comprised between 3% and 60% mol, preferably between 5% and 20% mol; the process comprising:
a) subjecting said NOx containing gas to a compression step to yield a pressure-adjusted gas;
b) subjecting said pressure-adjusted gas to a first heat recovery step to yield a temperature adjusted gas;
c) subjecting said temperature adjusted gas to a condensation step to yield a condensate stream and a nitrous gas;
d) subjecting said condensate stream and said nitrous gas to an absorption step in presence of make-up water and/or diluted nitric acid to yield a concentrated nitric acid and a tail gas containing residual NOx;
e) adjusting the temperature of said tail gas containing residual NOx by transferring heat from said pressure adjusted gas of step c) to said tail gas containing residual NOx to yield a heated tail gas;
f) subjecting said heated gas to an expansion step to recover power to be used in said compression step.

34. The process according to claim 33, wherein said heated tail gas, optionally after heating step, is subjecting to a NOx removal step before being conveyed to said expansion step.

35. A gas treatment section configured to treat a NOx-containing gas from a leaching section, wherein: in the leaching section, ores are contacted with a nitric acid to generate a diluted nitric acid solution containing target elements separated from said ores, and a NOx containing gas is produced; the gas treatment section comprising:
an absorption unit in fluid communication with said leaching section and configured to contact a NOx containing gas with a make-up water and/or diluted nitric acid to generate a concentrate nitric acid;
a low-pressure nitric acid recovery section comprising:
a low-pressure compressor and a low-pressure expander connected in series wherein said low-pressure compressor has an input that is fluid communication with said leaching section;
a low-pressure heat recovery section including a heat exchanger and a low-pressure condenser, said low-pressure heat recovery section is in fluid communication with an outlet of said low-pressure compressor and with an inlet of said absorption unit;
a line connecting said absorption unit with said low-pressure expander;
a driver connected with said low-pressure compressor section and with said low-pressure expander section and arranged to transmit power to said low-pressure compressor section;
a high-pressure nitric acid recovery section in communication with said low-pressure heat recovery section and with said absorption unit, wherein said high-pressure nitric acid recovery section includes:
a high-pressure compressor and a high-pressure expander connected in series wherein said high-pressure compressor has an input that is in fluid communication with said low-pressure heat recovery section;
a high-pressure heat recovery section including a heat exchanger and a high-pressure condenser wherein said heat exchanger is in fluid communication with an outlet of said high-pressure compressor;
a line connecting said high-pressure heat recovery section with said absorption section.

36. The gas treatment section according to claim 35, further comprising a line arranged to recycle at least part of said concentrated nitric acid back to said leaching section for use of said concentrated nitric acid as a leaching agent.

37. The gas treatment section according to claim 35 wherein said low-pressure compressor and said high-pressure compressor and said low-pressure expander and said high-pressure expander are arranged in a series of multiple machine sections or arranged as multiple machines in parallel.

38. A plant, comprising:
a leaching section; and
a gas treatment section according to claim 35, wherein the gas treatment section is connected to the leaching section so that the NOx-containing gas generated in the leaching section can be treated in the gas treatment section.
